(19) United States
(12) Patent Application Publication
(10) Pub. No.: US 2015/0061953 A1
(43) Pub. Date: Mar. 5, 2015

(54) Antenna and Electronic Device

(71) Applicant: Wistron NeWeb Corporation, Hsinchu (TW)

(72) Inventors: Chia-Tien Li, Hsinchu (TW); Kuan-Hung Ho, Hsinchu (TW); Yang Tai, Hsinchu (TW); Ta-Lung Yen, Hsinchu (TW)

(21) Appl. No.: 14/339,461

(22) Filed: Jul. 24, 2014

(30) Foreign Application Priority Data
Sep. 5, 2013 (TW) 102132042

(51) Int. Cl. H01Q 5/00; H01Q 1/22; H01Q 1/48

(52) U.S. Cl. CPC H01Q 5/0024; H01Q 1/48; H01Q 1/2258
USPC 343/749

(57) ABSTRACT

An antenna for an electronic device includes a grounding sheet for providing grounding, a metal sheet having a shape substantially corresponding to a rectangular with a first section at a first corner, a feed-in unit electrically connected to the metal sheet corresponding to a second corner adjacent to the first corner of the rectangular, for transmitting electromagnetic energy, and a shorting wall electrically connected to the grounding sheet and a first side of the metal sheet, for forming a resonating cavity, wherein the first side is opposite to a second side of the metal sheet, and the second side is adjacent to the first and second corners, wherein a length and a width of the rectangular are respectively related to frequency ranges of at least one operating frequency band, and the first section increases a frequency range of a first frequency band of the operating frequency bands.

### BACKGROUND OF THE INVENTION

1. Field of the Invention

The present invention relates to an antenna and an electronic device, and more particularly, to an antenna and an electronic device having characteristics of wideband, multiband or broadband, small size, high efficiency, etc.

2. Description of the Prior Art

An antenna is utilized for transmitting or receiving radio frequency waves so as to communicate or exchange wireless signals. An electronic product with wireless communication functionality, such as a notebook and a personal digital assistant (PDA), usually accesses a wireless network through a built-in antenna. Therefore, to facilitate access to the wireless communication network, an ideal antenna should have a wide bandwidth and a small size to meet the trends of compact electronic products within a permissible range, so as to integrate the antenna into a portable wireless communication equipment. However, with advances in wireless communication technology, operating frequencies of different wireless communication systems may vary, and thereby, an ideal antenna should cover bandwidths required for different wireless communication networks with a single antenna.

In the prior art, for multiband applications, a common method is to utilize multiple antennas or multiple radiators (such as slots of a slot antenna, branches of a dipole antenna, etc.) to respectively transmit and receive signals of different frequency bands, which causes increase of deign complexity and space for settling the antennas. If the available space for the antennas is limited, interference may occur among the antennas, which significantly affects performance of the antennas. Therefore, providing an antenna that allows multiband operation under limited space is a significant objective in the field.

### SUMMARY OF THE INVENTION

It is therefore a primary objective of the present invention to provide a multiband antenna and electronic device so as to achieve multiband or wideband operation in a limited area.

An embodiment of the present invention discloses an antenna for an electronic device, comprising a grounding sheet, for providing grounding; a metal sheet, having a shape substantially corresponding to a rectangle and a first section formed at a first corner of the rectangle; a feed-in element, electrically connected to the metal sheet at a location corresponding to a second corner of the rectangle, for transmitting electromagnetic energy, wherein the second corner is adjacent to the first corner; and a shorting wall, electrically connecting a first side of the metal sheet with the grounding sheet, for allowing the grounding sheet and the metal sheet to form a resonating cavity, wherein the first side is an opposite side of a second side of the metal sheet, and the second side is adjacent to both the first corner and the second corner; wherein a length and a width of the rectangle to which the metal sheet corresponds are respectively related to frequency ranges of the at least an operating frequency band of the antenna, and the first section of the metal sheet is utilized for widening a frequency range of a first frequency band of the at least an operating frequency band.

An embodiment of the present invention further discloses an electronic device, comprising an operation circuit; a metal housing, covering the operation circuit, and forming an open window; and an antenna, disposed on the metal housing and near the open window, comprising a grounding sheet, for providing grounding, electrically connected to the metal housing; a metal sheet, having a shape substantially corresponding to a rectangle and a first section formed at a first corner of the rectangle; a feed-in element, electrically connected to the metal sheet at a location corresponding to a second corner of the rectangle, for transmitting electromagnetic energy between the operation circuit and the metal sheet, wherein the second corner is adjacent to the first corner; and a shorting wall, electrically connecting a first side of the metal sheet with the grounding sheet, for allowing the grounding sheet and the metal sheet to form a resonating cavity, wherein the first side is an opposite side of a second side of the metal sheet, and the second side is adjacent to both the first corner and the second corner; wherein a length and a width of the rectangle to which the metal sheet corresponds are respectively related to frequency ranges of the at least an operating frequency band of the antenna, and the first section of the metal sheet is utilized for widening a frequency range of a first frequency band of the at least an operating frequency band.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1A to 1D are schematic diagrams of an isometric view, a side view, a front view, and a back view of an antenna according to an embodiment of the present invention.

FIG. 2A is a schematic diagram of a patch antenna with symmetric feed-in structure.

FIG. 2B is a schematic diagram of a patch antenna with asymmetric feed-in structure.

FIGS. 2C and 2D are schematic diagrams illustrating electric field directions of the antenna shown in FIG. 2B.

FIG. 2E is a schematic diagram of a patch antenna with a shorting wall.

FIG. 3A is a schematic diagram of distribution of surface electrical field vectors of the antenna shown in FIG. 1A when operating in a low frequency band.

FIG. 3B and FIG. 3C are schematic diagrams of distribution of surface electrical field vectors of the antenna shown in FIG. 1A when operating at high frequency bands.

FIGS. 4A to 4D are schematic diagrams of antennas according to different embodiments of the present invention.

FIGS. 5A and 5B are schematic diagrams of an isometric view and a front view of an antenna according to an embodiment of the present invention.

FIG. 5C is a schematic diagram of voltage standing wave ratio (VSWR) of the antenna shown in FIG. 5A.

FIGS. 6A to 6C are schematic diagrams of VSWR, an antenna efficiency, and an antenna pattern of the antenna shown in FIG. 5A.

FIGS. 7A to 7C are schematic diagrams of VSWR, an antenna efficiency, and an antenna pattern of the antenna shown in FIG. 5A.

FIGS. 8A and 8B are schematic diagrams of a front view and a partially sectional view of an integrated computer system.

FIG. 9 is a schematic diagram of a notebook.

FIGS. 10A and 10B are schematic diagrams of two operation modes of a notebook with a tablet function therein.

FIGS. 11A to 11E are schematic diagrams of VSWR, an antenna efficiency, and an antenna pattern of the antenna shown in FIG. 5A applied in the notebook shown in FIGS. 10A and 10B.

FIGS. 12A to 12C are schematic diagrams of different embodiments of a fixing element of the antenna shown in FIG. 1A.

### DETAILED DESCRIPTION

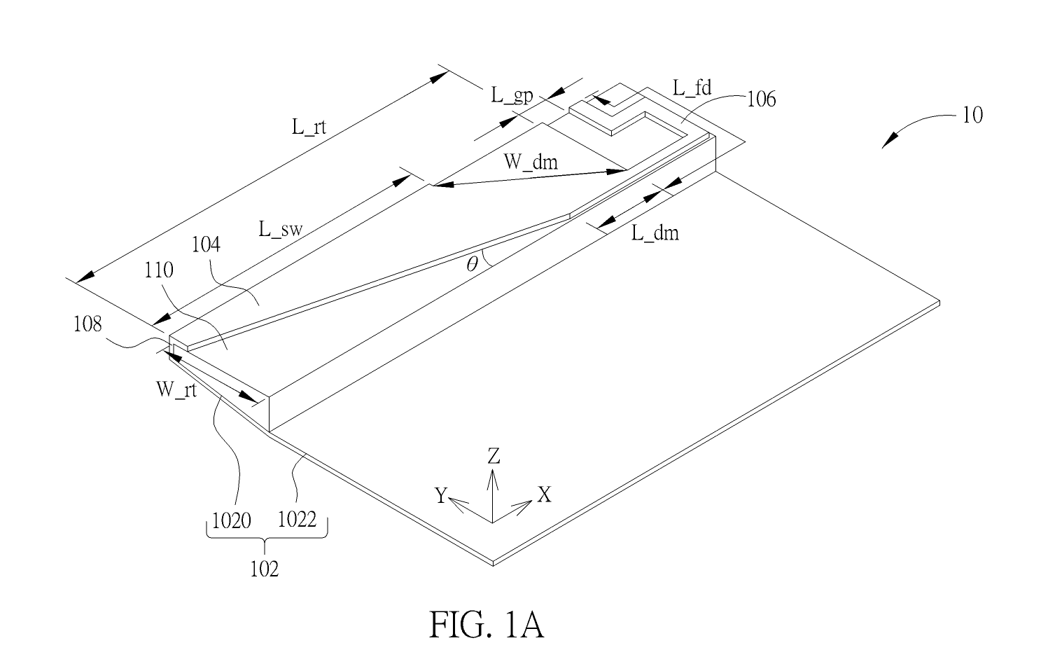

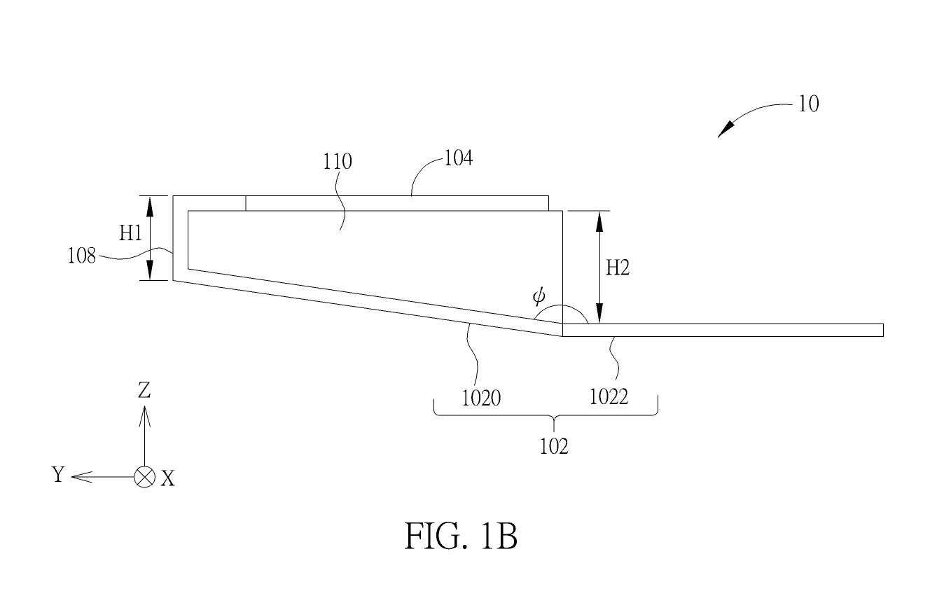

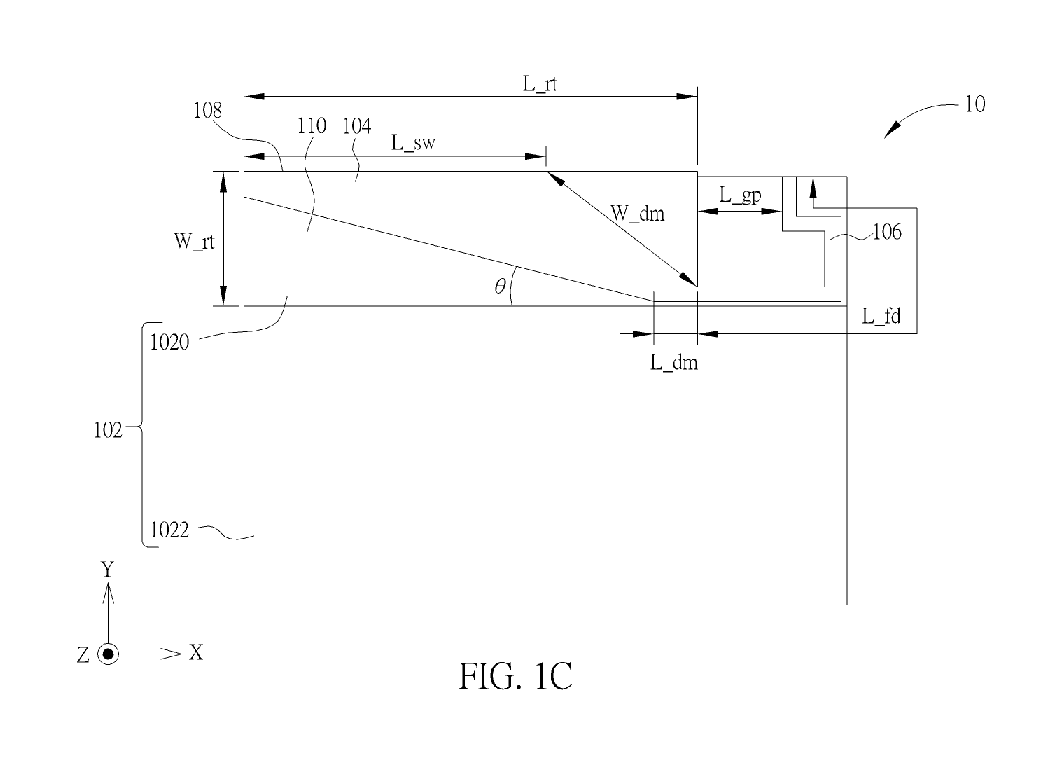

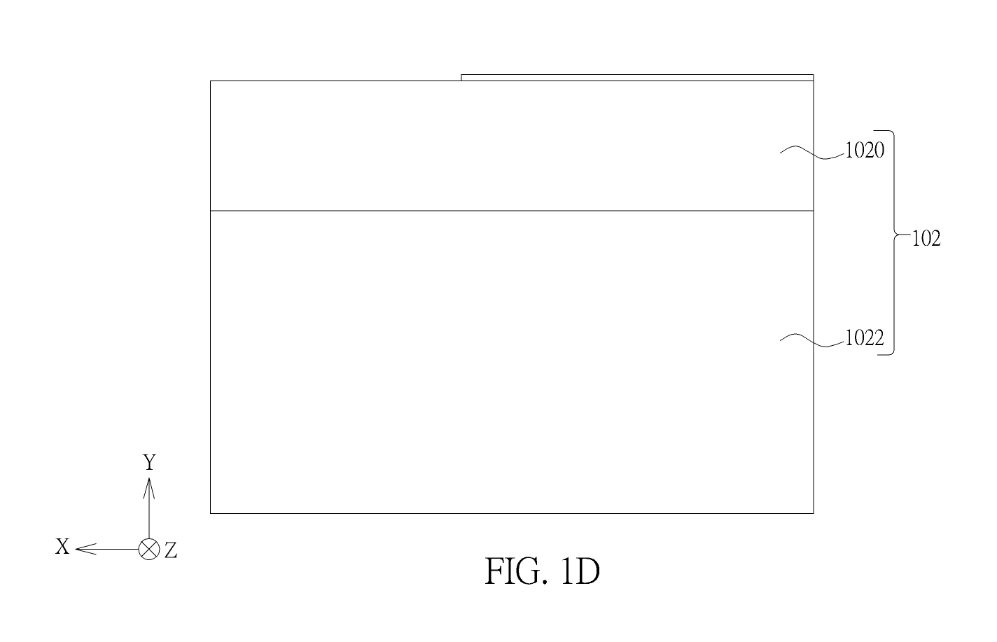

Please refer to FIGS. 1A to 1D. FIGS. 1A to 1D are schematic diagrams of an isometric view, a side view, a front view, and a back view of an antenna 10 according to an embodiment of the present invention, respectively, with a coordinate system labeled by X, Y, and Z axes to represent the viewing perspective. The antenna 10 may be utilized in a portable electronic device with wireless communication function to transmit and receive wireless signals on at least one frequency band. The portable electronic device may be a notebook, a personal digital assistant, etc., but not limited thereto. The antenna 10 includes a grounding sheet 102, a metal sheet 104, a feed-in element 106, a shorting wall 108, and a fixing element 110. The grounding sheet 102 is utilized for providing grounding, i.e., the grounding sheet 102 is connected to a ground of the portable electronic device, and includes a first block 1020 and a second block 1022, wherein the first block and the second block are disposed to form an included angle φ. In this embodiment, the included angle θ may be accommodated to a structural design of the portable electronic device. The metal sheet 104 may cooperate with the grounding sheet 102 to perform transmission or reception of the wireless signals. As shown in FIG. 1A and FIG. 1C, a shape of the metal sheet 104 may be regarded as a geometric pattern formed by removing a section from a rectangle with a length L_rt and a width W_rt, or removing a right-angled triangle with an angle θ at a top corner from the rectangle with the length L_rt and the width W_rt. In addition, as shown in FIG. 1B, the metal sheet 104 is substantially located on the above of the first block 1020 of the grounding sheet 102; i.e., from a front view of the antenna 10, as shown in FIG. 1C, the metal sheet 104 overlaps with the first block 1020. The feed-in element 106 is electrically connected to a corner of the metal sheet 104 for delivering electromagnetic energy, and the corner is adjacent to the section. In other words, the antenna 10 feeds in wireless signals in an asymmetric way. The shorting wall 108 is electrically connected to the metal sheet 104 and a side of the grounding sheet 102, such that a resonant cavity is formed between the grounding sheet 102 and the metal sheet 104. A length and a height of the shorting wall 108 are respectively L_sw and H1. Furthermore, the fixing element 110 may be made of plastic or other non-conductive materials to fix the relative position between the metal sheet 104 and the grounding sheet 102, such that a distance between another side of the metal sheet 104 not connecting to the shorting wall 108 and the grounding sheet 102 has a height H2.

As can be seen, a structure of the antenna 10 is similar to a patch antenna. However, different from the traditional patch antennas, the antenna 10 has an asymmetric feed-in structure, a shorting wall, a section, etc. The operation principle of the antenna 10 is narrated in the following.

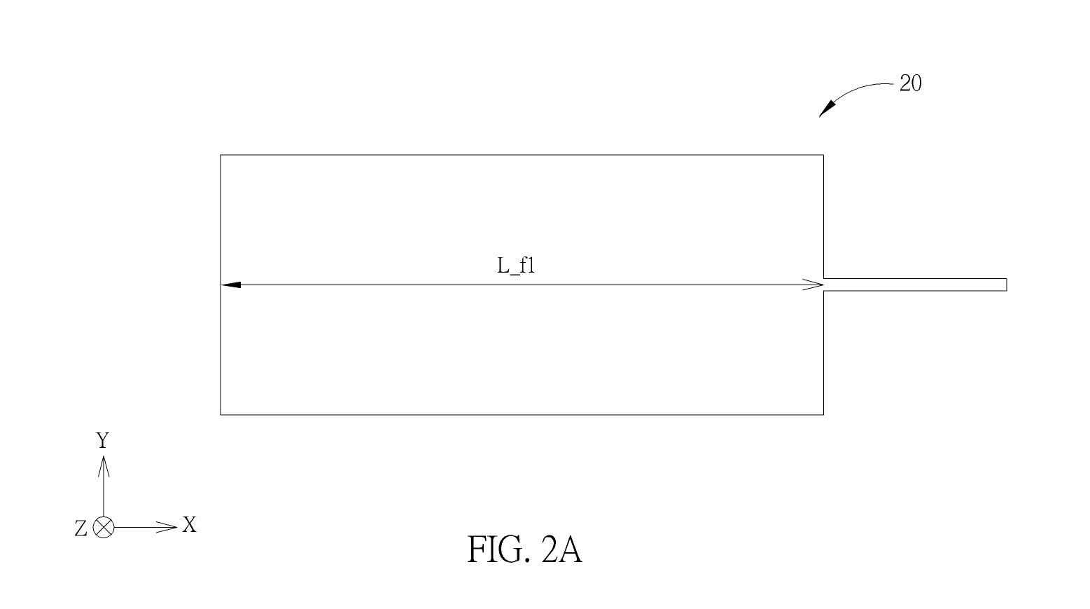

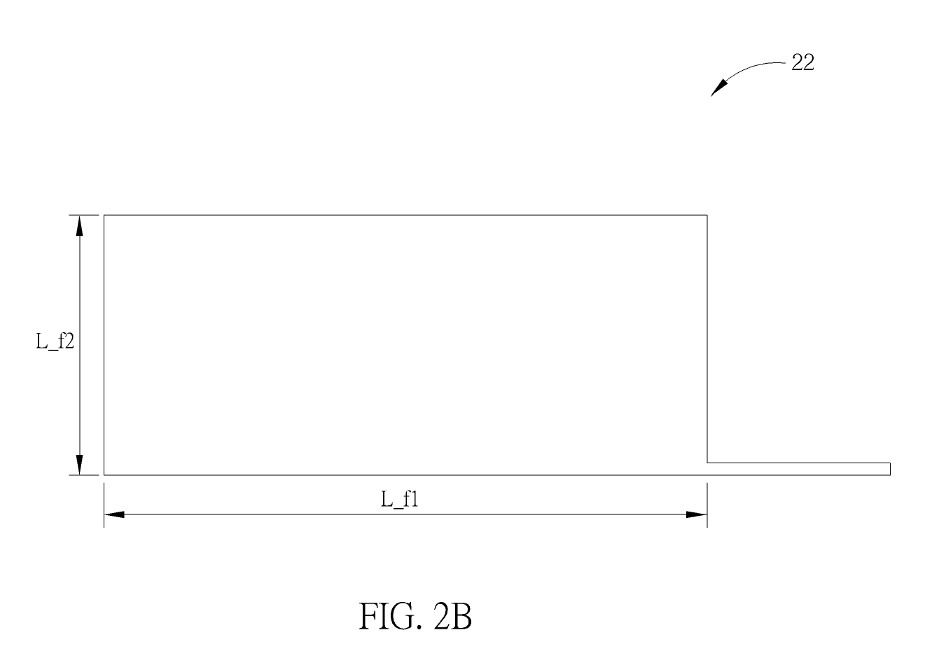

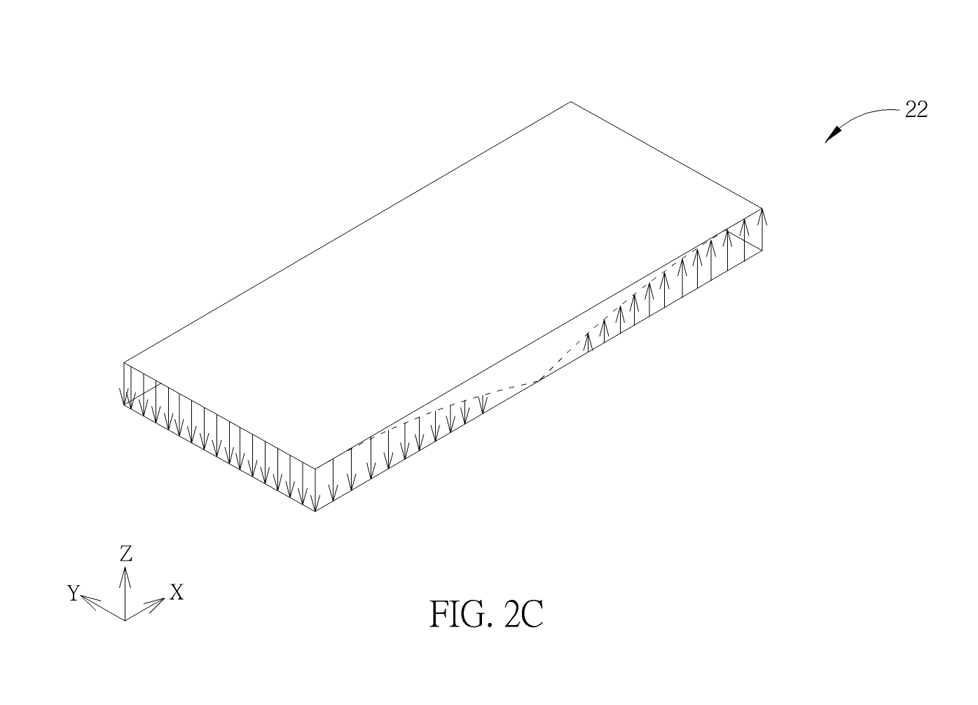

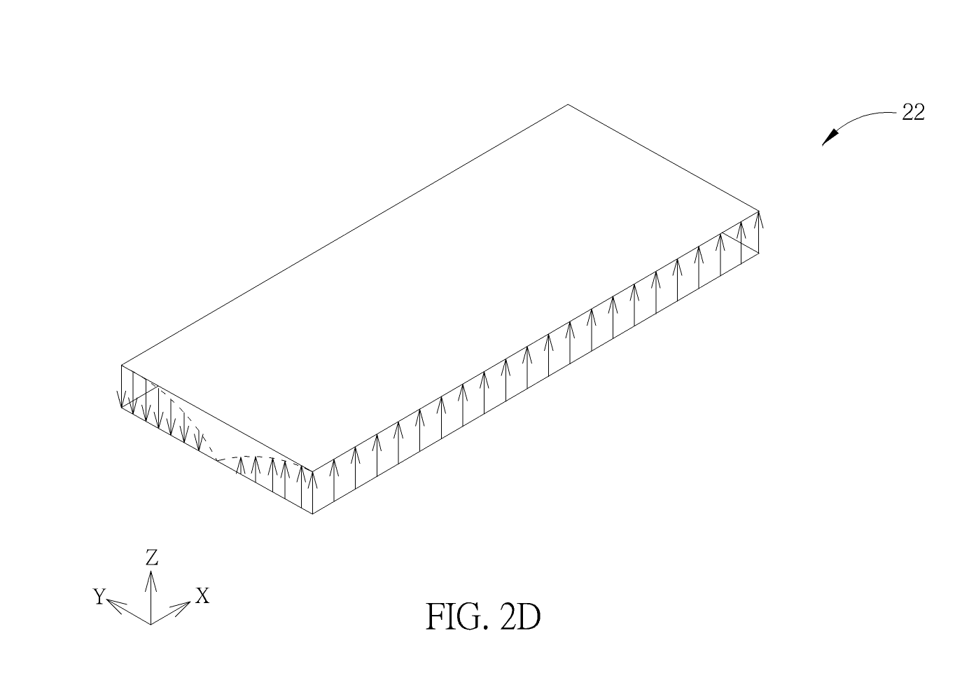

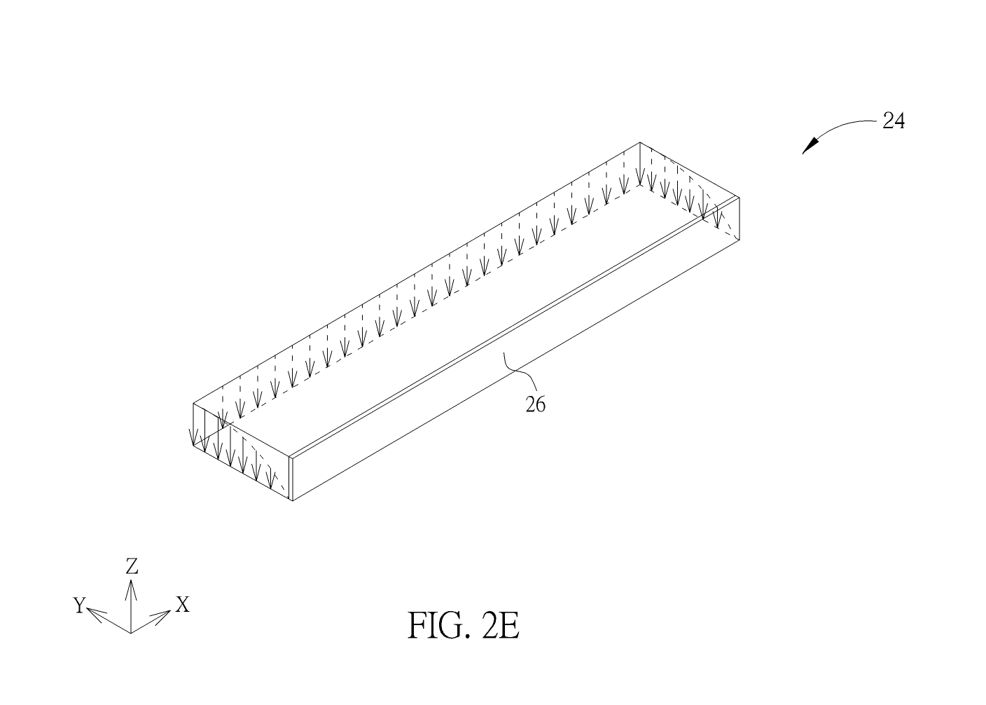

First, as described in the above, the feed-in element 106 is electrically connected to a corner of the metal sheet 104 to achieve asymmetric feed-in. Conventionally, as shown in FIG. 2A, a patch antenna 20 utilizes a central (symmetrical) feed-in structure, and a length L_f1 of the patch antenna 20 is substantially equal to a half of a wavelength of a signal corresponding to a frequency f1, in order to transmit and receive signals of the frequency f1. In other words, the conventional patch antenna 20 achieves only single-band operation. In comparison, the antenna 10 utilizes asymmetric feed-in, as a patch antenna 22 shown in FIG. 2B to illustrate relative concepts. In addition to controlling the length L_f1 to be substantially equal to a half of a wavelength of a signal corresponding to the frequency f1, a width L_f2 is controlled to be substantially equal to a half of a wavelength of a signal corresponding to the frequency f2. As a result, the patch antenna 22 generates resonant points corresponding to the frequencies f1, f2 in X and Y axes, respectively, as shown in FIG. 2C and FIG. 2D (wherein arrows indicate electric field directions), such that a dual-band operation is achieved.

Furthermore, as can be seen from FIG. 2D, a resonant zero point is generated at a middle line of the patch antenna 22 along the Y axis. If the middle line of the patch antenna 22 is connected to a ground, the resonant operation along the Y axis is maintained and does not affect the original operation along the X axis. Thus, as shown in FIG. 2E, a patch antenna 24 is formed by connecting the middle line of the patch antenna 22 along the Y axis to the ground by a shorting wall 26, such that a width of the patch antenna 24 is reduced to L_f2/2.

As can be seen from the above, with the asymmetrical feed-in structure, the antenna 10 may achieve the dual-band operation. With the shorting wall 108, the width W_rt of the antenna 10 is effectively decreased. Thus, for the applications of the 2.4 GHz and 5 GHz frequency bands of wireless local area network (WLAN) as an example, the length L_rt and the width W_rt of the metal sheet 104 are respectively related to the resonant positions of the frequency bands of 2.4 GHz and 5 GHz. More specifically, the length L_rt of the antenna 10 is substantially equal to a half of a wavelength of the high-frequency (5 GHz) signal, and the width W_rt of the antenna 10 is substantially equal to a quarter of a wavelength of the low-frequency (2.4 GHz) signal. Nevertheless, note that by controlling the length L_sw of the shorting wall 108, the width W_rt is further less than the quarter of the wavelength of the low-frequency signal. In detail, the length L_sw of the shorting wall 108 may affect the shortest distance from the feed-in point (i.e. the connecting point between the feed-in element 106 and the metal sheet 104) to the ground, and the shortest distance is related to a central frequency of the low frequency band. Thus, when the available space is limited, the length L_sw of the shorting wall 108 may be decreased, such that the shortest distance from the feed-in point to the ground may be lengthened from W_rt to W_dm; i.e., the central frequency of the low-frequency band may be determined by the distance W_dm. Therefore, the width W_rt may be further reduced to be less than the quarter of the wavelength of the low-frequency signal.

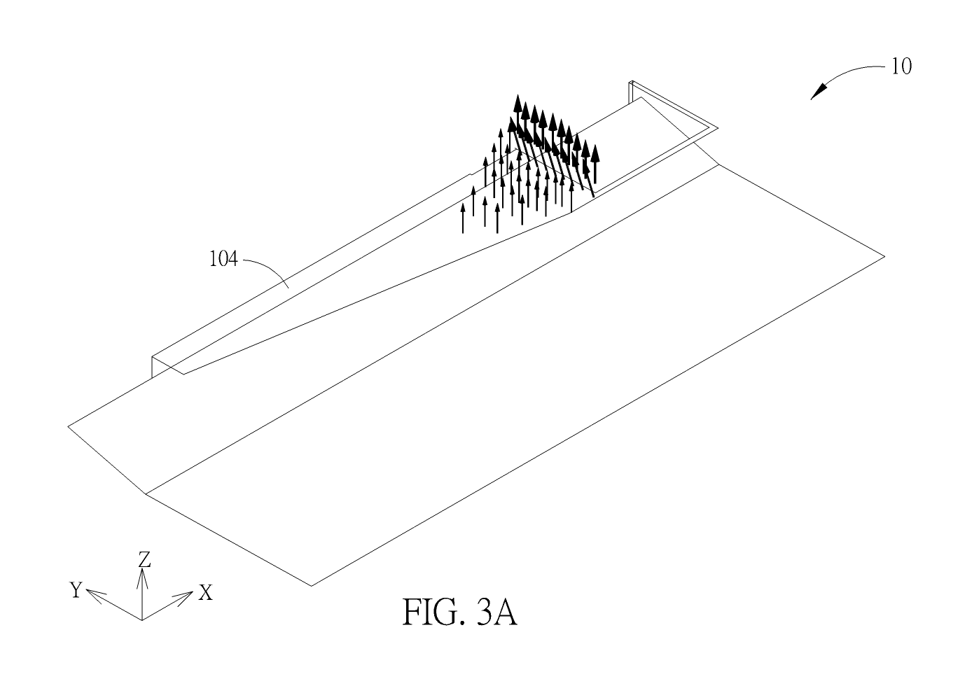

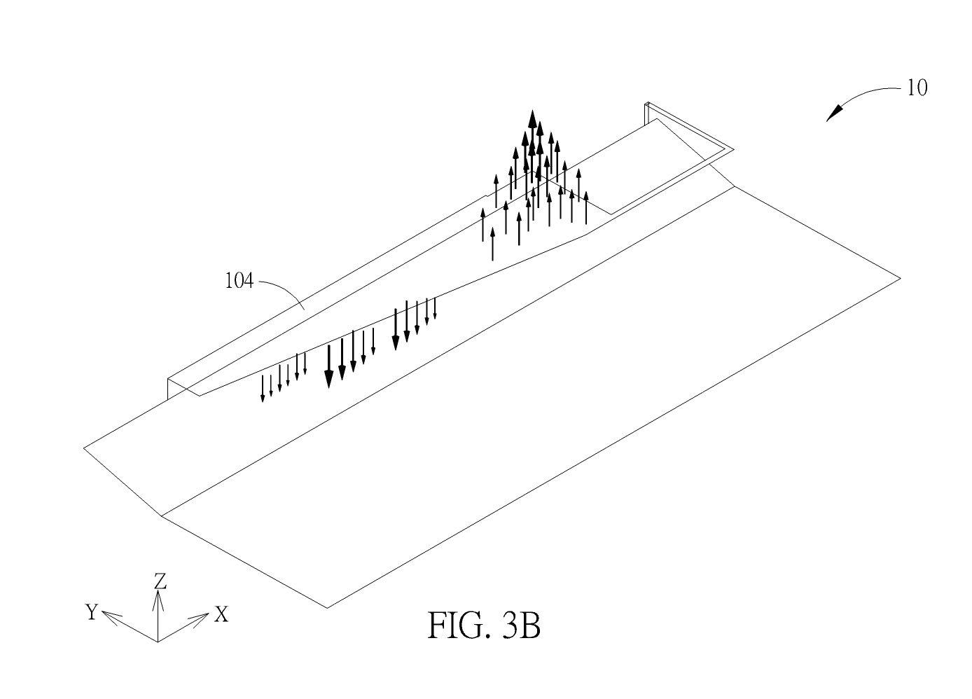

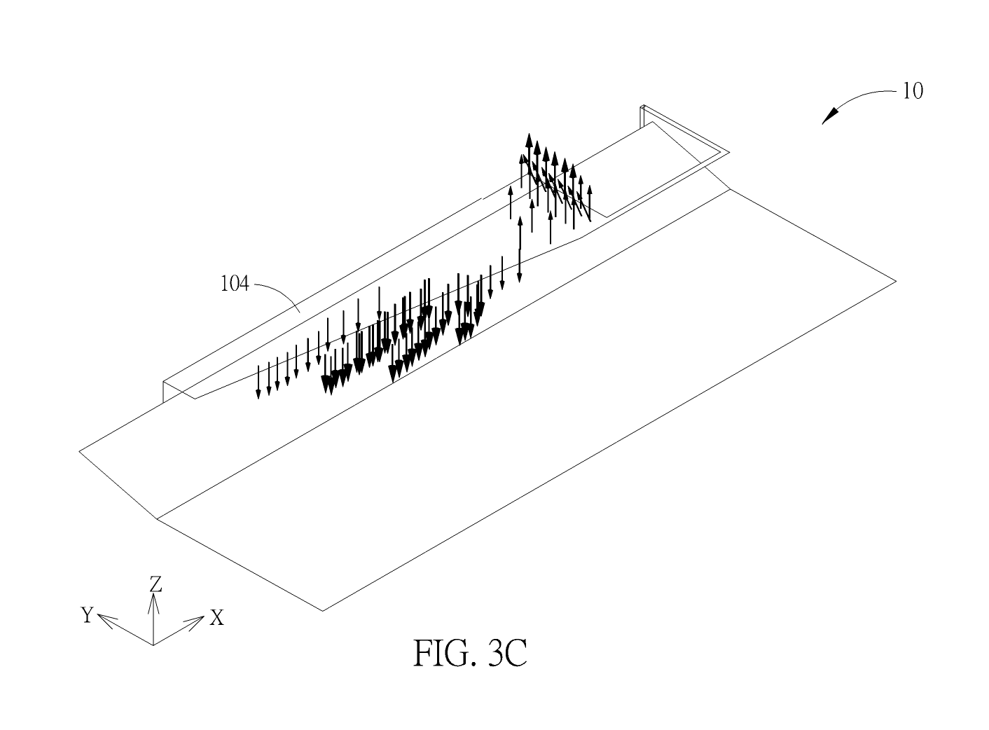

Moreover, since the length L_rt of the metal sheet 104 is related to the high-frequency operation. Taking WLAN for example, the high-frequency bands have to cover 18 percent of bandwidth from 5 GHz to 6 GHz, much greater than the low-frequency bands which cover 4 percent of bandwidth from 2.4 GHz to 2.5 GHz. Accordingly, the present invention further utilizes a section method, in order to shorten a length of one side of the metal sheet 104 (i.e. the opposite side of the side connecting to the shorting wall 108) linearly from L_rt to L_dm, such that the operating frequency range at high frequencies is effectively extended. In other words, the section with the angle θ provides the metal sheet 104 a variation in length from L_rt to L_dm, such that more high-frequency paths are provided, generating multiple patterns. For example, please refer to FIGS. 3A to 3C. FIG. 3A is a schematic diagram of distribution of surface electrical field vectors of the metal sheet 104 when the antenna 10 operates in low frequency bands, and FIG. 3B and FIG. 3C are schematic diagrams of distribution of surface electrical field vectors of the metal sheet 104 when the antenna 10 operates in two high frequency bands. In FIGS. 3A-3C, an arrow represents a direction of electric field, and a length of the arrow represents the relative intensity of electric field. As can be seen from FIGS. 3B and 3C, due to the variation in length of the metal sheet 104, the metal sheet 104 generates different patterns in the high-frequency bands, thereby enlarging the range of high-frequency band, such that broadband operation is achieved. Notably, FIGS. 3A to 3C show the distribution of the electric field vectors inside the resonant cavity. In fact, fringing field exists along with edges of the metal sheet. Nevertheless, in any case, the radiation directions of the antenna 10 are mainly toward the outside of the grounding sheet 102, instead of toward the grounding sheet 102.

In addition, in the antenna 10, the feed-in element 106 is made of a microstrip line, and the feed-in element 106 can be a quarter wavelength impedance converter. As literally implied, the length L_fd of the feed-in element 106 is substantially equal to a quarter of a wavelength of a wireless signal corresponding to the low-frequency band. In fact, the actual length L_fd of the feed-in element 106 is determined by an impedance point of the metal sheet 104, such that the length L_fd is substantially around ⅛ to ⅜ of the wavelength of the wireless signal corresponding to the low-frequency band. In detail, the method of metal edge feed-in causes high impedance; therefore, the present invention uses Smith chart tools to adjust the length L_fd, so as to match the impedance point close to 50 ohms, to accordingly enhance the transmission efficiency, and thereby improve the radiation efficiency.

As can be concluded from the above, the antenna 10 of the embodiment of the present invention utilizes the asymmetrical feed-in structure for enabling a dual-band operation, utilizes the shorting wall 108 for reducing the width required, utilizes the section for generating multiple patterns at high frequencies to increase the range of the high-frequency band, and utilizes the quarter wavelength impedance converter for matching the impedance point to 50 ohm to improve the transmission efficiency.

Notably, the antenna 10 is an embodiment of the present invention, and those skilled in the art can make modifications or alterations accordingly. For example, as shown in FIG. 1B, the height H2 is greater than the height H1 of the shorting wall 106, but not limited thereto. The height H2 may be equal to the height H1. In general, even though the larger heights H1 and H2 result in better radiation efficiencies, the heights H1 and H2 have to be kept in a certain range, e.g., the minimum of the heights are not allowed to be less than 2 mm, to ensure that the fringing electric field between the grounding sheet 102 and the metal sheet 104 radiates to free space.

Furthermore, as described in the above, the length L_sw of the shorting wall 108 is related to the central frequency of the low-frequency band, and by shortening the length L_sw of the shorting wall 108, the width W_rt is less than a quarter of the wavelength of a low-frequency signal. For example, if the antenna 10 is implemented by an iron material and air is the medium, a quarter of a wavelength of the 2.4 GHz signal is 31.25 mm. By utilizing the shorting wall 108 to lengthen the low frequency resonant path, the width W_rt may be less than 10 mm, i.e., 68% reduction compared to 31.25 mm. Nevertheless, note that in order to prevent destroying the electric field distribution of the metal sheet 104 at low and high frequencies, the length L_sw may be set to be greater than an eighth of a wavelength of a wireless signal corresponding to the high-frequency band.

Moreover, the width and the shape of the feed-in element 106 are not limited as long as the length of the feed-in element 106 matches the impedance point close to 50 ohm. For example, in the antenna 10, the width of the feed-in element 106 is uniform, and the feed-in element 106 includes 3 bends. However, in other embodiments, the feed-in element 106 may be tapper, or include more, less, or no bend. Notably, in order to avoid interfering with the fringing field of the metal sheet 104, the distance L_gp between the feed-in element 106 and the metal sheet 104 should satisfy the following condition:

L_{—}gp>0.24λr+0.375*(H1+H2);

wherein λr is the wavelength of the wireless signal corresponding to the low-frequency band.

On the other hand, in the antenna 10, the grounding sheet 102 is divided into the first block 1020 and the second block 1022, to distinguish a part (i.e., the first block 1020) covered by the metal sheet 104 (or the resonant cavity) from another part (i.e. the second block 1022) not covered by the metal sheet 104. In fact, the first block 1020 and the second block 1022 may be different segments of a same metal sheet, or may also be different metal sheets which are electrically connected. Notably, since the second block 1022 is on a slot opening direction of the low frequency path, the second block 1022 has to be made of a conductive material (such as conductive plastic, conductive gasket, welding material, or copper material) and connected to the ground, in order to maintain the fringing field effect. The first block 1020 is below the resonant cavity, and due to the skin depth effect, the electromagnetic characteristic is only inside the resonator, such that the first block 1020 may be connected to the ground by an insulating adhesive and not need to directly connect to the ground. In addition, if an applied electronic device has a metal back or a metal frame, a conductive material such as conductive gasket has to be introduced, in order to conduct the second block 1022 to the metal back or the metal frame and to enhance grounding effect. In such a situation, influence of the metal back or the metal frame on the antenna properties may be avoided, so as to maintain good bandwidth, efficiency and antenna patterns. Meanwhile, as described in the above, since the radiation direction of the antenna 10 is mainly toward the outside of the grounding sheet 102, the radiation efficiency is not affected under an operating environment with the metal back or the metal frame.

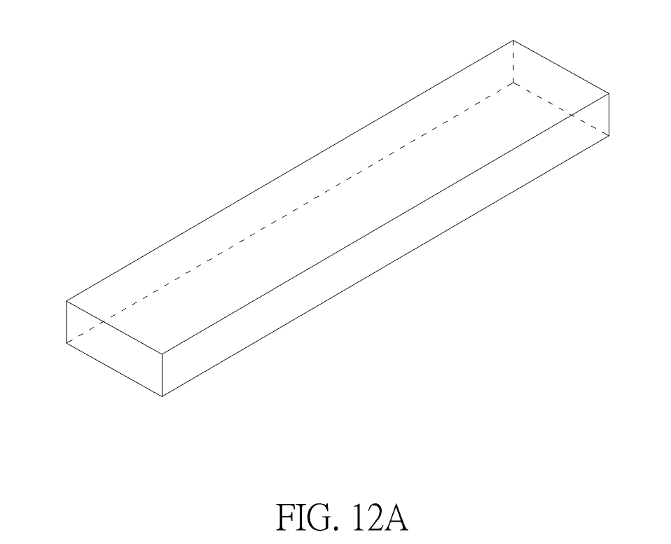

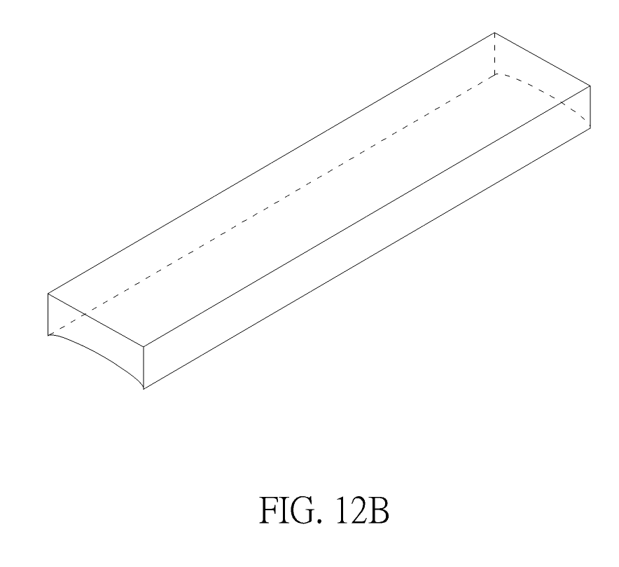

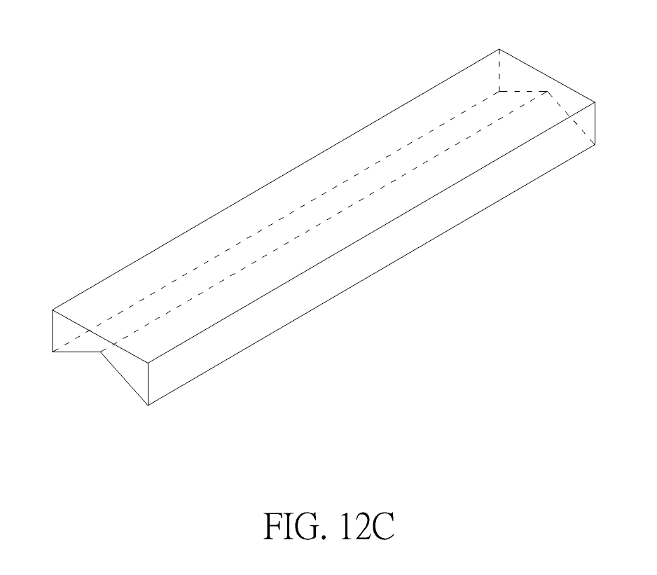

In addition, the first block 1020 and the metal sheet 104 are fixed with each other by the fixing element 110. In other embodiments, if the first block 1020 and the metal sheet 104 can be fixed without the fixing element 110, e.g., by the shorting wall 108, the fixing element 110 may also be removed. Moreover, as shown in FIG. 1B, a lateral of the fixing element 110 is trapezoid, which is to accommodate the structure design. In other embodiments, as shown in FIG. 12A to FIG. 12C, the lateral of the fixing element 110 may also be rectangular, or with arcs surface or section, etc., which depends on different applications. Alternatively, the fixing element 110 may also be implemented by one or more cylinders or blocks, but not limited thereto. For the material of the fixing element 110, the only requirement is to make sure that the fixing element 110 is made of an insulation material, and it is not limited to either hard or soft material.

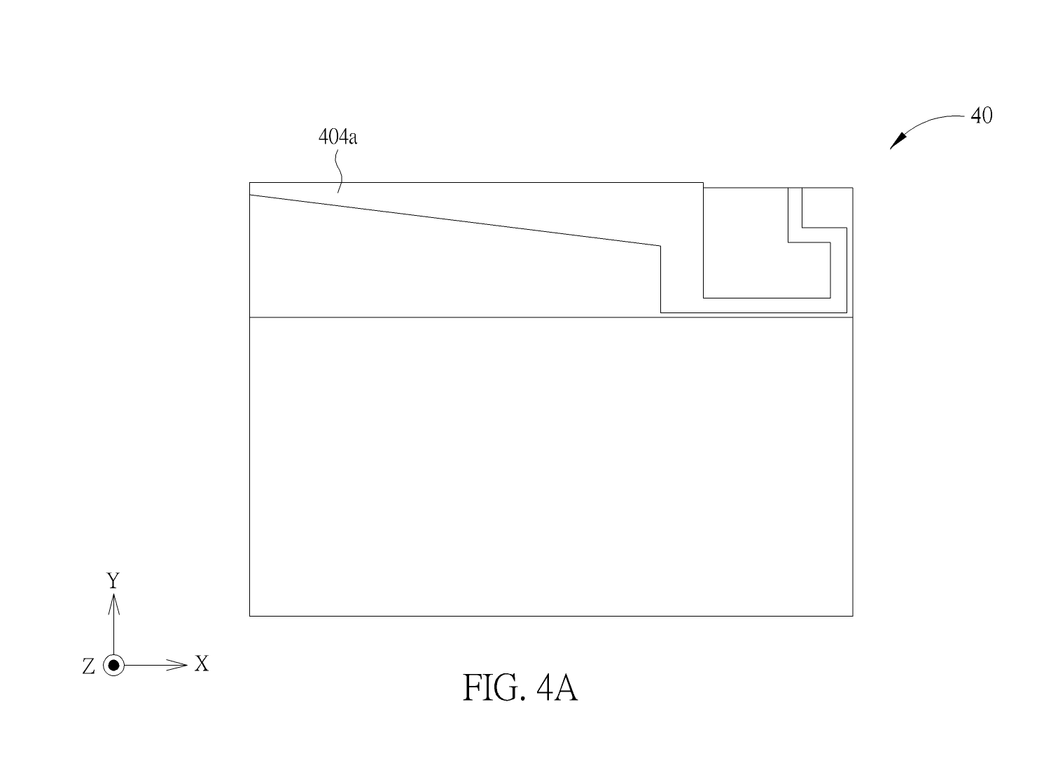

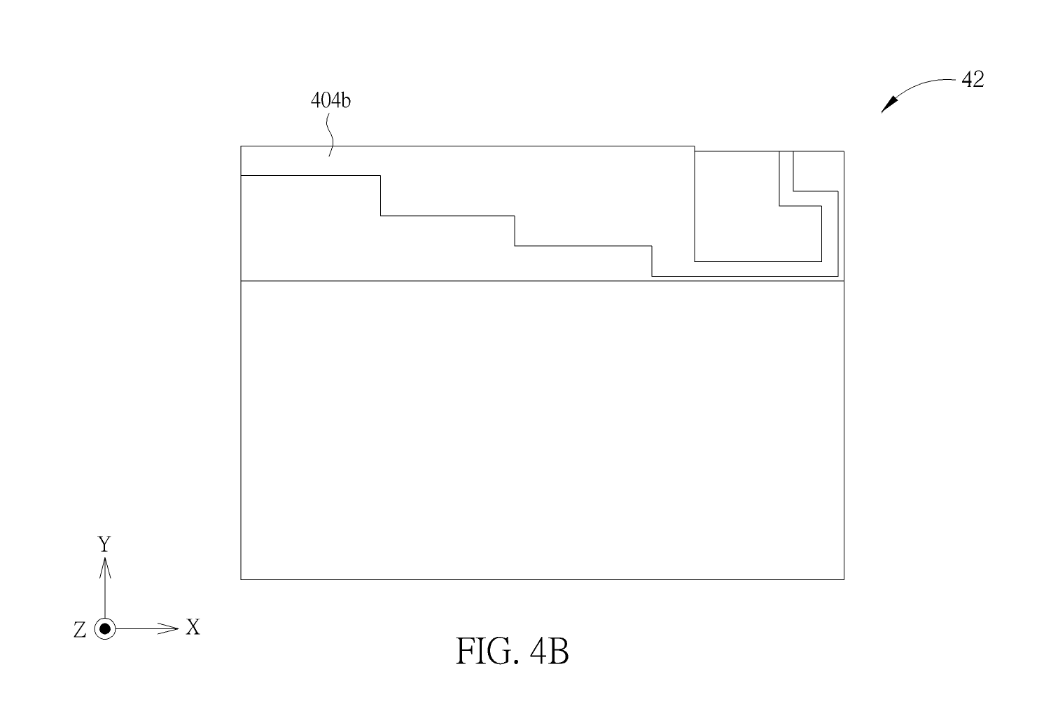

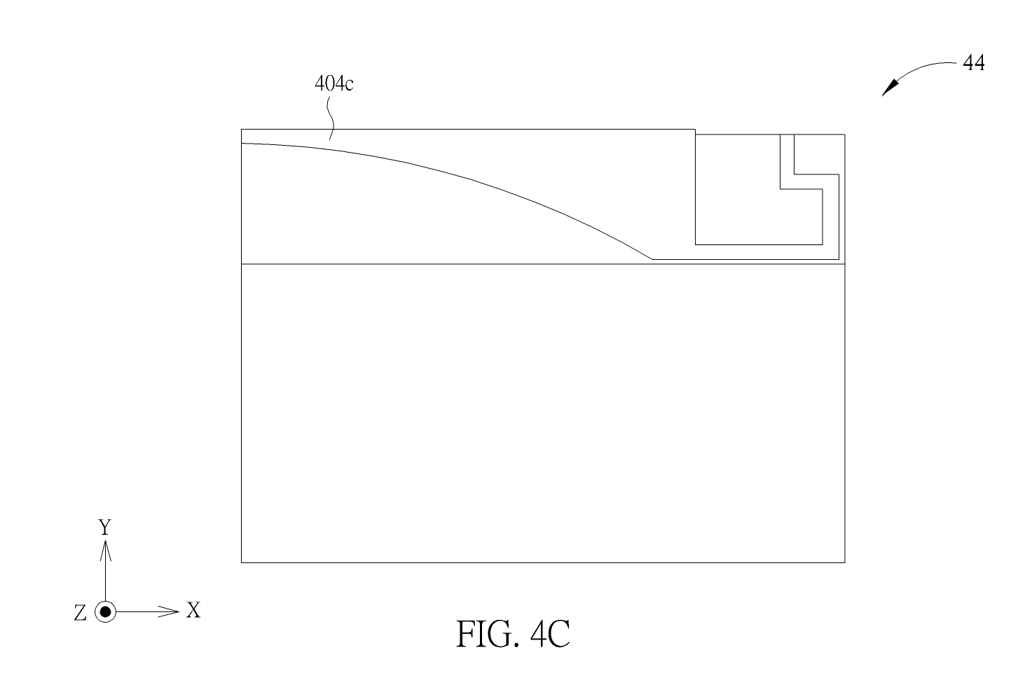

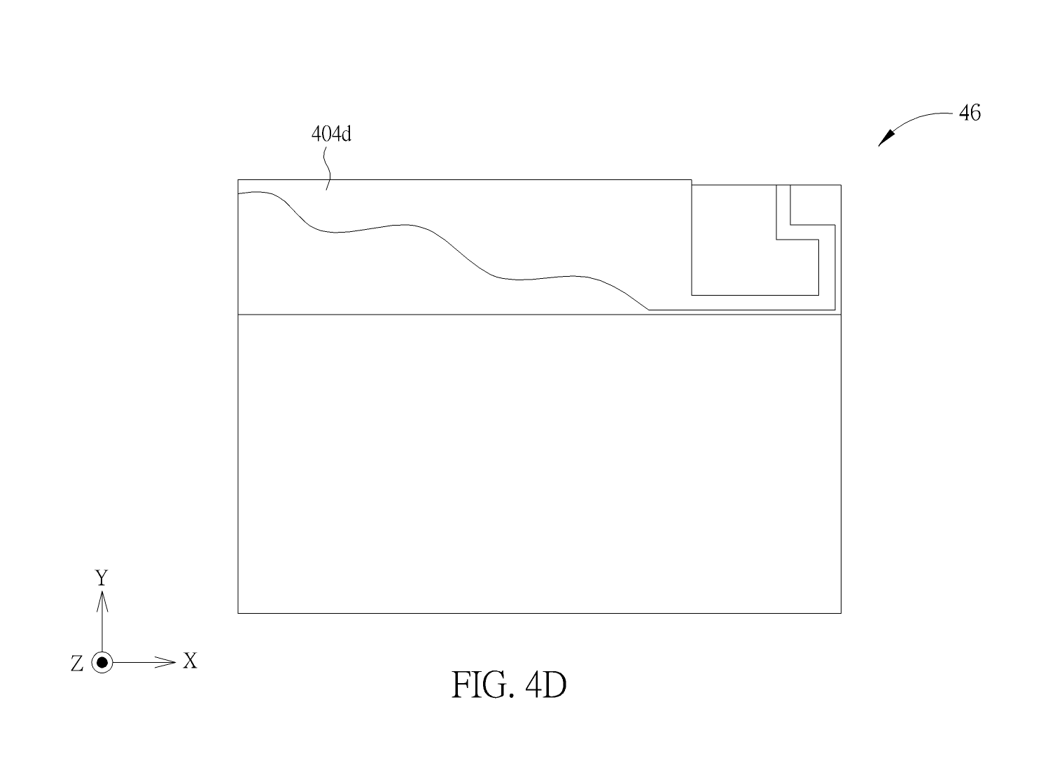

In the antenna 10, the section with the angle θ makes the length of the metal sheet 104 to vary from L_rt to L_dm, in order to extend the range of the high-frequency operating bands. To avoid over affection of the current paths of low-frequency signals, the angle θ may be set between 0 and 30 degrees, but not limited thereto. In such a situation, those skilled in the art may adjust the angle θ or modify the shape of the section adequately, based on the system requirement, which is not limited to the embodiments of FIGS. 1A to 1C. For example, please refer to FIGS. 4A to 4D. FIGS. 4A to 4D are schematic diagrams of antennas 40, 42, 44, and 46, respectively, according to embodiments of the present invention. Since the structures of the antenna 40, 42, 44, 46 are similar to the structure of the antenna 10, the notations of the same components are omitted. Different from the antenna 10, a section of a metal sheet 404a of the antenna 40 is trapezoid, a section of a metal sheet 404b of the antenna 42 is stepwise, a section of a metal sheet 404c of the antenna 44 is in arc shape, and a section of a metal sheet 404d of the antenna 46 is sinusoidal. Besides the shapes of the sections, the rest structures of the antennas 40, 42, 44, and 46 are similar to the antenna 10. Thus, the antennas 40, 42, 44, and 46 may also achieve advantages as broadband, multiband, small size, high efficiency, etc.

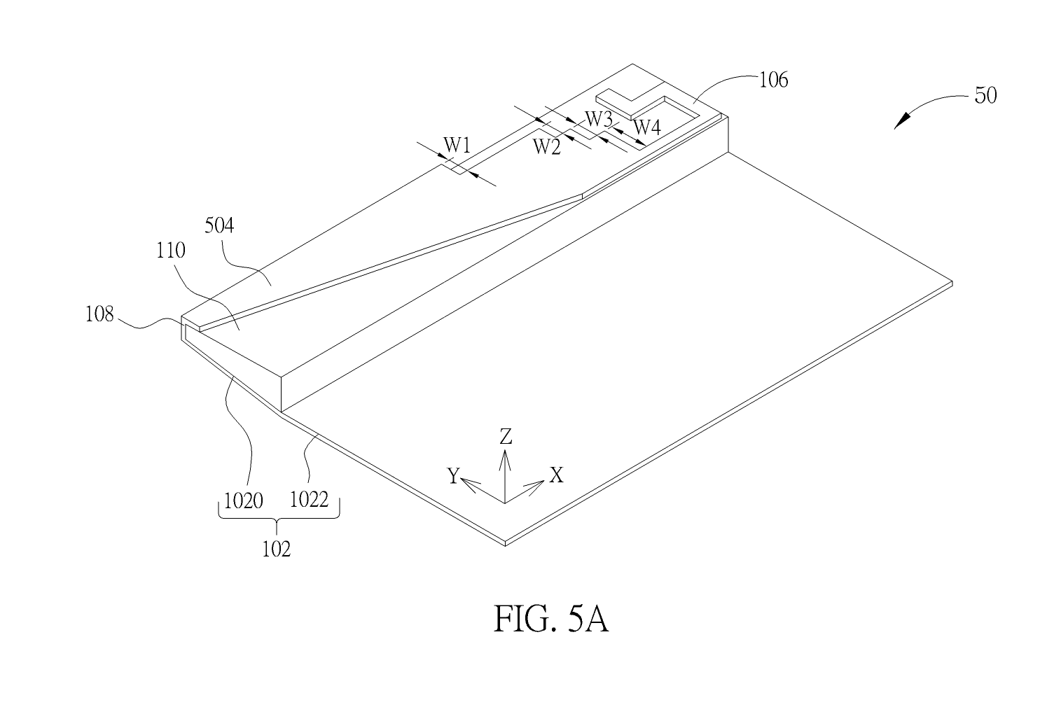

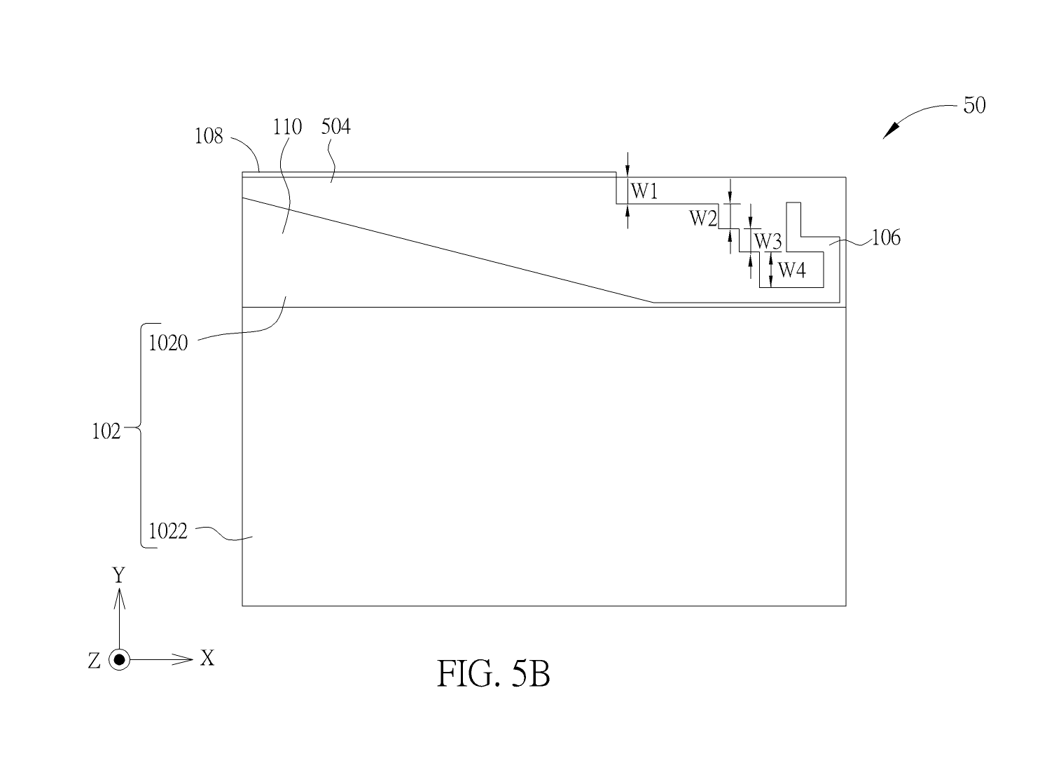

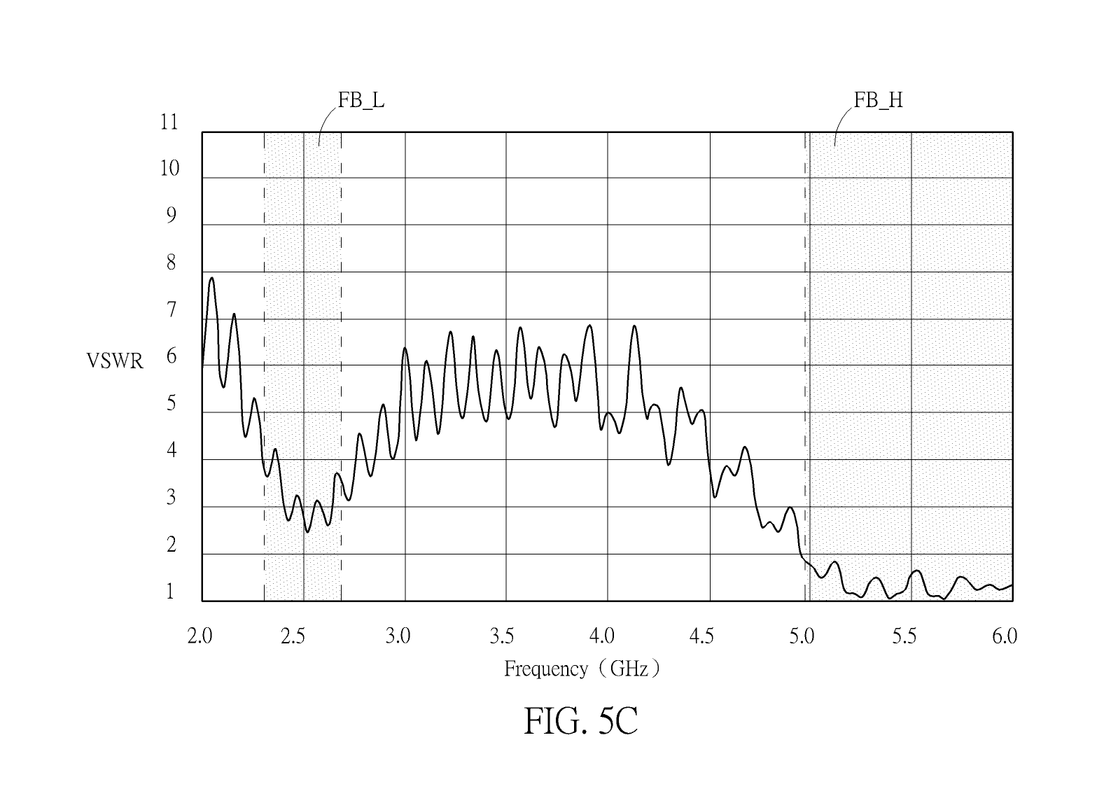

Notably, FIG. 4A to FIG. 4D are to exemplify that the angle θ, the shape, the position of the section of the metal sheet 104 may be modified adequately, in order to generate a system required variation in length of the metal sheet 104, so as to activate proper high frequency patterns. In addition, in another embodiment of the present invention, another section may be added to the metal sheet 104 at the opposite direction of the aforementioned section, in order to add another length adjusting mechanism, such that fine-tuning of matching or frequency band range is achieved. For example, please refer to FIGS. 5A and 5B. FIGS. 5A and 5B are schematic diagrams of an isometric view and a front view of an antenna 50 according to an embodiment of the present invention, with a coordinate system labeled by X, Y, and Z axes to represent the viewing perspective. Since the structure of the antenna 50 is similar to that of the antenna 10 shown in FIGS. 1A to 1D, the notations of the same components remain the same. Different from the antenna 10, an additional section is added to a metal sheet 504 in comparison to the metal sheet 104 of the antenna 10. The section in the metal sheet 504 is stepwise with step sizes W1-W4. The step sizes W1-W4 may effectively adjust the impedance matching at both high and low frequencies.

Notably, the additional section of the metal sheet 504 in comparison to the metal sheet 104 is utilized for providing different length adjusting mechanism, such that high-frequency bands may be continued. Thus, the shape and the position of the additional section may be modified adequately according to FIG. 1A or FIGS. 4A to 4D.

For example, in an embodiment, for the applications of 2.4 GHz and 5 GHz frequency bands of WLAN, the step sizes W2-W4 may have a relationship as follows:

W2:W3:W4=1:2:2

Accordingly, the antenna 50 may achieve VSWR as shown in FIG. 5C. As can be seen from FIG. 5C, a low-frequency operation band FB_L of the antenna 50 satisfies the WLAN requirement of 2.4 GHz, and a high frequency operation band FB_H substantially covers 5 GHz to 6 GHz and accommodates multiple consecutive frequency bands via the section mechanism, so as to completely satisfy the WLAN requirement of 5 GHz.

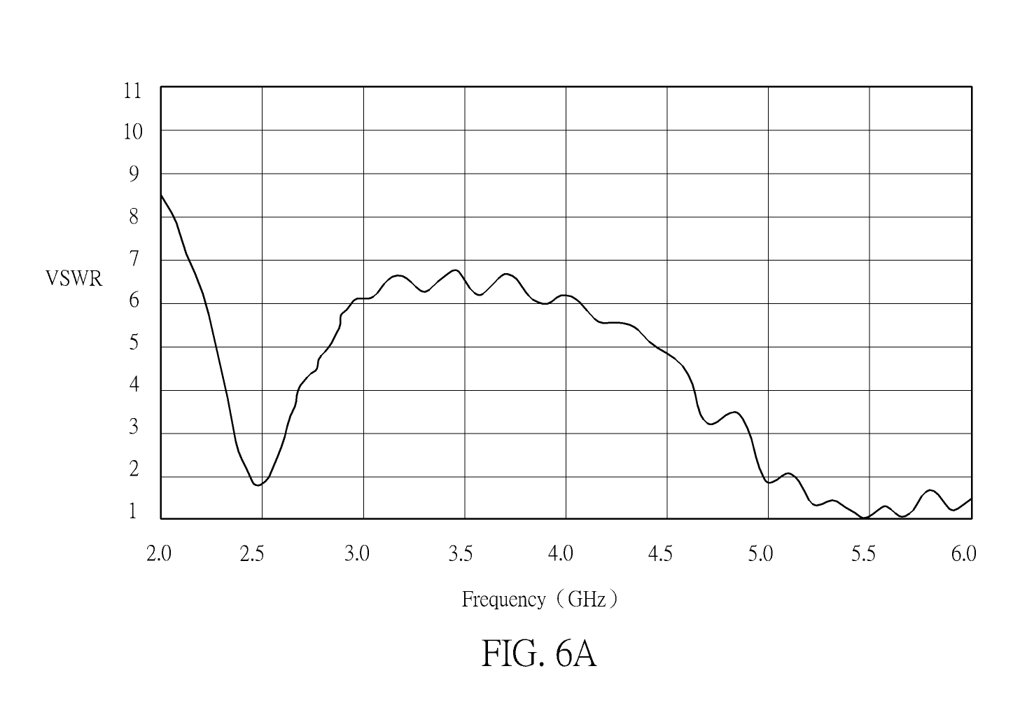

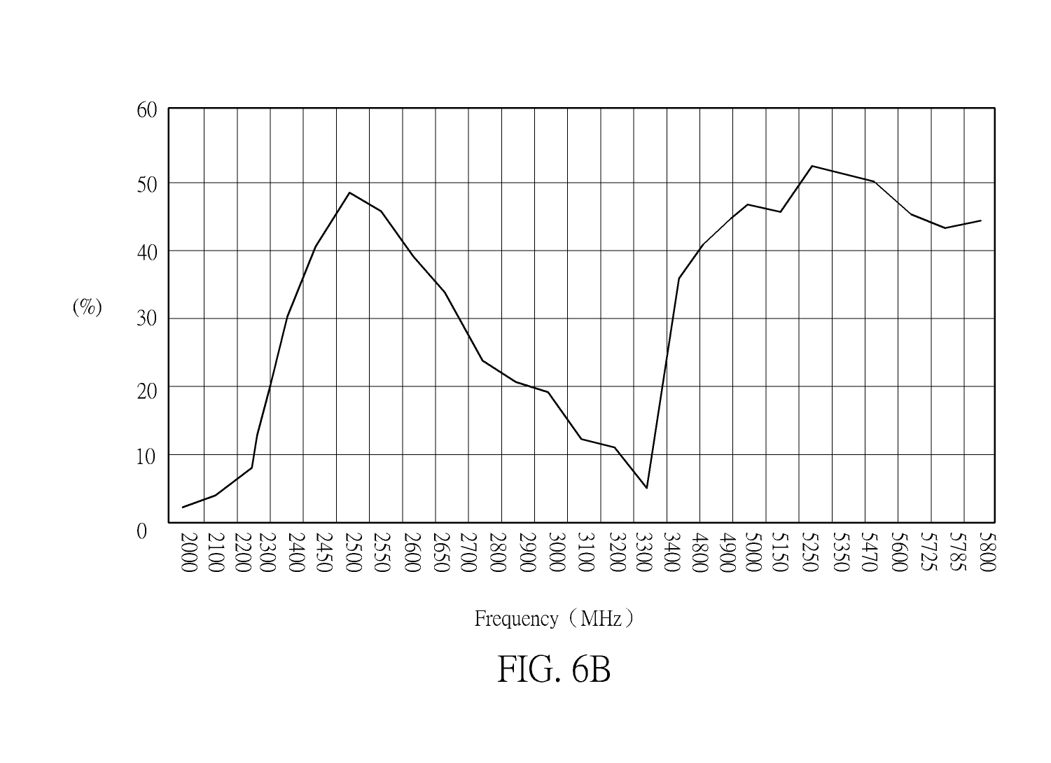

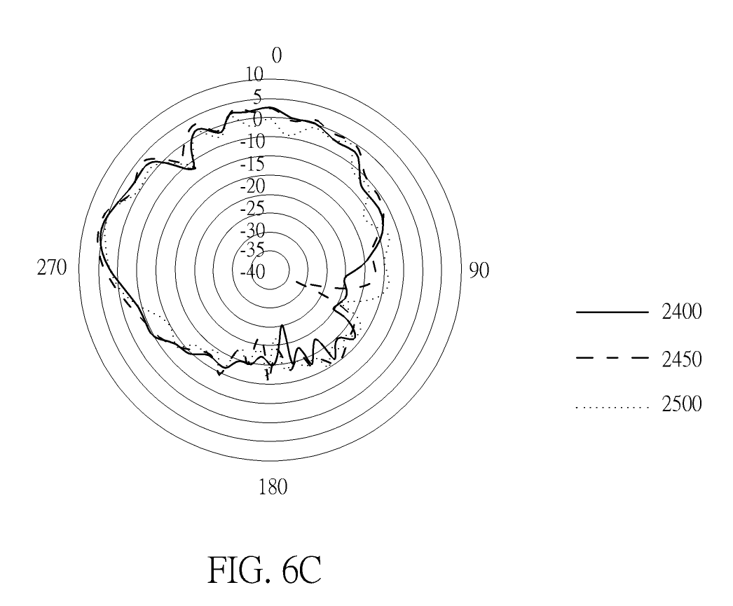

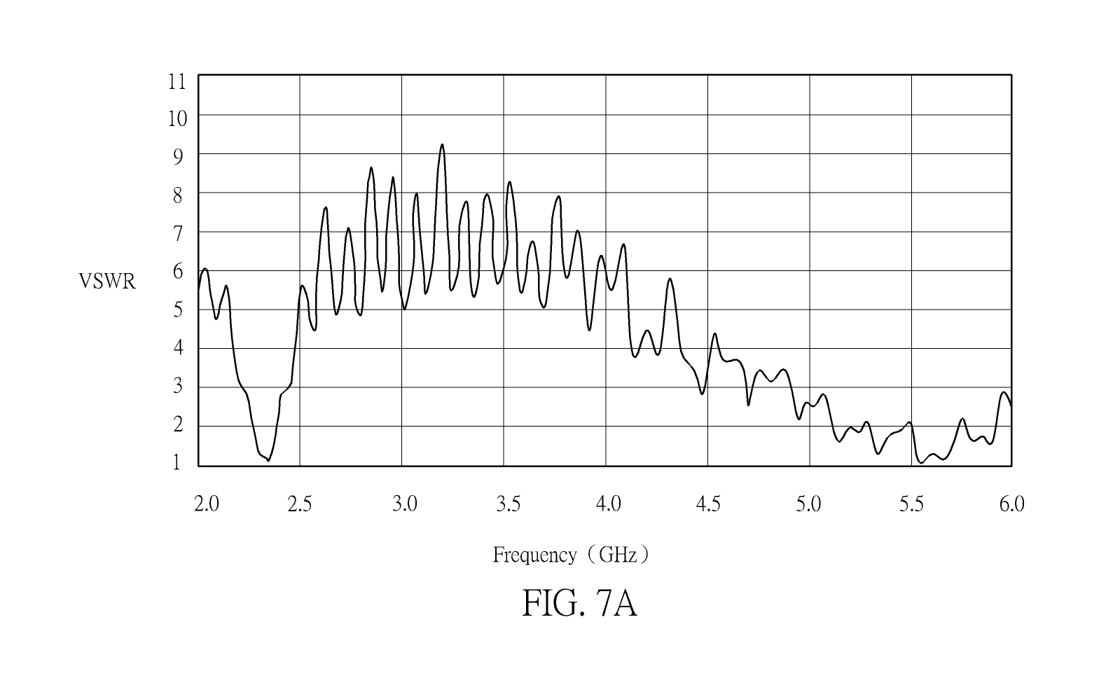

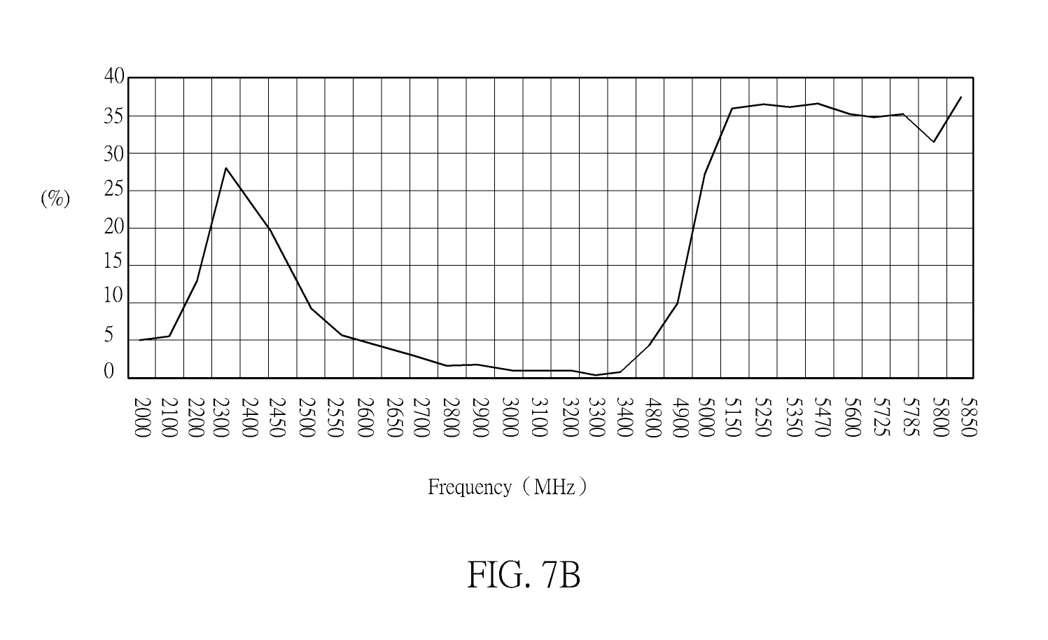

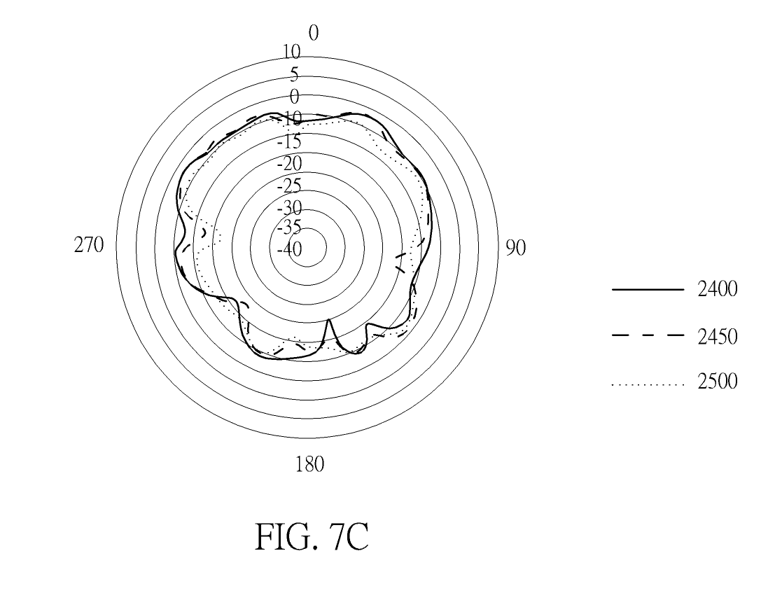

Additionally, since the antennas (10, 40-46, and 50) of the embodiments of the present invention utilize different mechanisms to increase resonant paths or bandwidths, such as the shorting wall, the section, the quarter wavelength feed-in, etc., the required area may be effectively reduced. For the 2.4 GHz and 5 GHz applications of the WLAN as an example, an antenna, with a length between 35 mm and 60 mm, a width between 10 mm and 13 mm, and a height no less than 2 mm, may still satisfy the WLAN requirements in terms of efficiency and bandwidth according to the present invention. For example, please refer to FIGS. 6A to 6C and FIGS. 7A to 7C. FIGS. 6A to 6C are schematic diagrams of VSWR, antenna efficiency, and antenna pattern of the antenna 50 with the length, width, and height set to 60 mm, 13 mm, and 3 mm, respectively. FIGS. 7A to 7C are schematic diagrams of VSWR, antenna efficiency, and antenna pattern of the antenna 50 with the length, width, and height set to 35 mm, 10 mm, and 3 mm, respectively. In FIG. 6C and FIG. 7C, solid lines, dashed lines, and dotted lines represent the antenna patterns at 2400 MHz, 2450 MHz, and 2500 MHz, respectively. As can be seen from FIGS. 6A to 7C, even though the dimension of the antenna 50 is lessened, the antenna 50 still maintains good bandwidth, efficiency and antenna pattern.

As can be seen from the above, the antennas (10, 40-46, and 50) of the present invention achieve the dual-band operation, reduce the required size, widen the range of the higher frequency band, and own good transmission efficiency. In such a situation, the antennas of the present invention are more suitable for harsh environments, such as small size or metal housing applications. Specifically, for an electronic device with a metal back cover or a metal frame, since the radiation direction of the antenna of the present invention is mainly toward the outside of the grounding sheet, the impact of the metal back or the metal frame on the antenna properties may be avoided to retain good bandwidth, efficiency and antenna pattern if the grounding sheet is electrically connected to the metal back cover or the metal frame. Notably, the so-called application of the metal housing represents that the operation circuits of the electronic device are substantially covered or partially covered by a housing made of a metal material, and to make sure that the electromagnetic wave is radiated properly, the antenna of the present invention should be disposed on an area which is not completely covered by the metal house; alternatively, if the metal housing is formed with an open window for disposing a screen, a keyboard or other components, the antenna of present invention may be disposed near the open window.

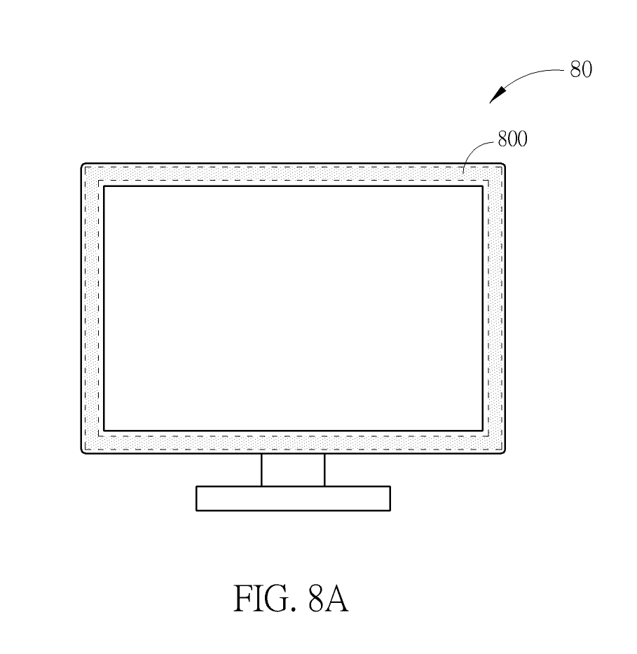

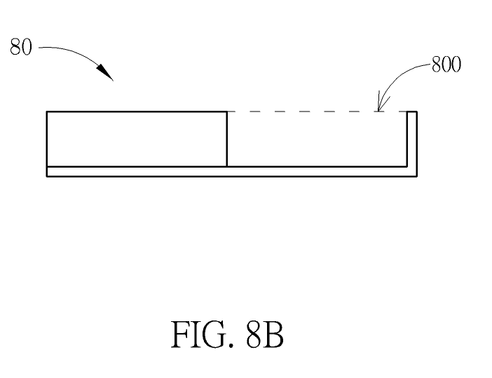

For example, please refer to FIGS. 8A and 8B. FIGS. 8A and 8B are schematic diagrams of a front view and a partially sectional view of an integrated computer system 80. The integrated computer system 80 integrates a computer mainframe and a touch screen, and may comprise a metal back cover or a metal housing, which means that the metal housing covers operating circuits of the computer mainframe. In such a situation, the antenna of the present invention may be disposed on a region 800 around the screen of the integrated computer system 80 (which can be seen as around a window of the metal housing), and the grounding sheet of the antenna is connected to the metal back, such that good bandwidth, efficiency, and antenna pattern are retained.

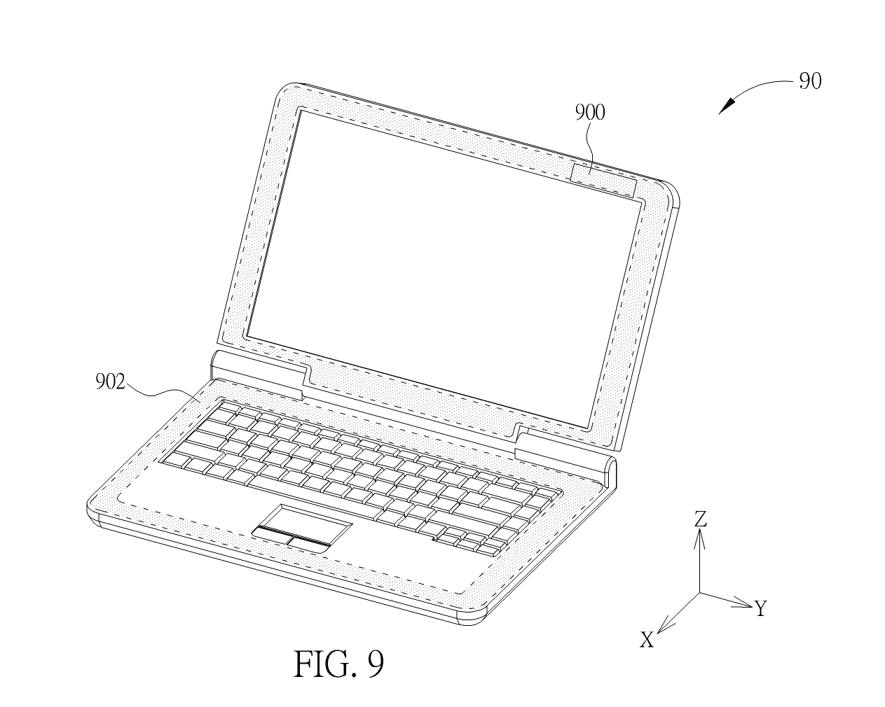

Please refer to FIG. 9. FIG. 9 is a schematic diagram of a notebook 90. The notebook 90 is mainly composed of an up cover and a base, which can be opened and closed repeatedly via a hinge connecting both the up cover and the base. The up cover mainly comprises a screen and an operating circuit of the screen, and the base mainly comprises a computer mainframe, a keyboard and the relative operating circuits. In such a situation, if the notebook 90 has a metal back cover or a metal housing, the antenna of the present invention may be disposed on a region 900 around the screen of the notebook 90 or on a region 902 around the keyboard, and the grounding sheet of the antenna is connected to the metal back, such that good bandwidth, efficiency, and antenna pattern are retained.

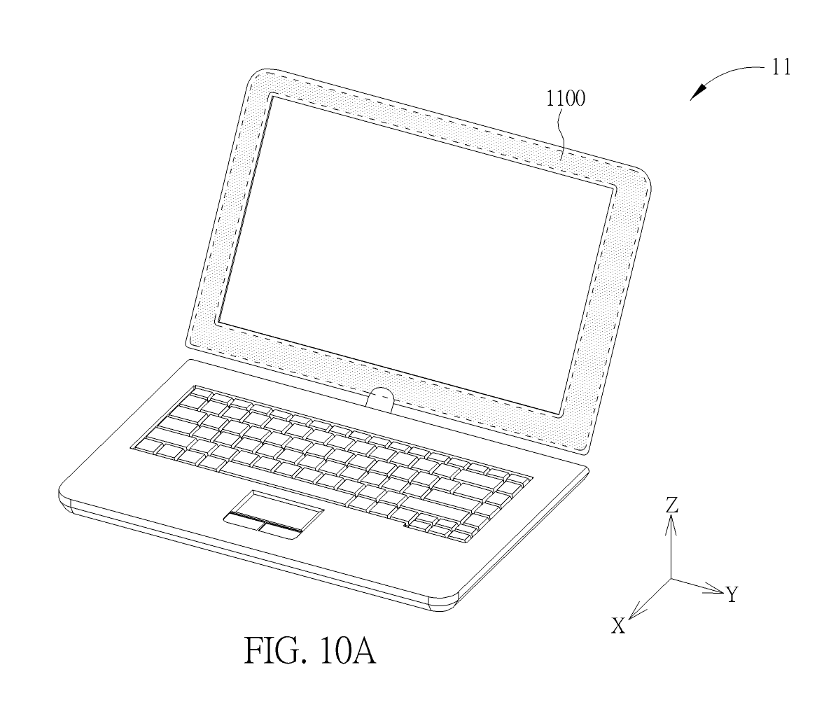

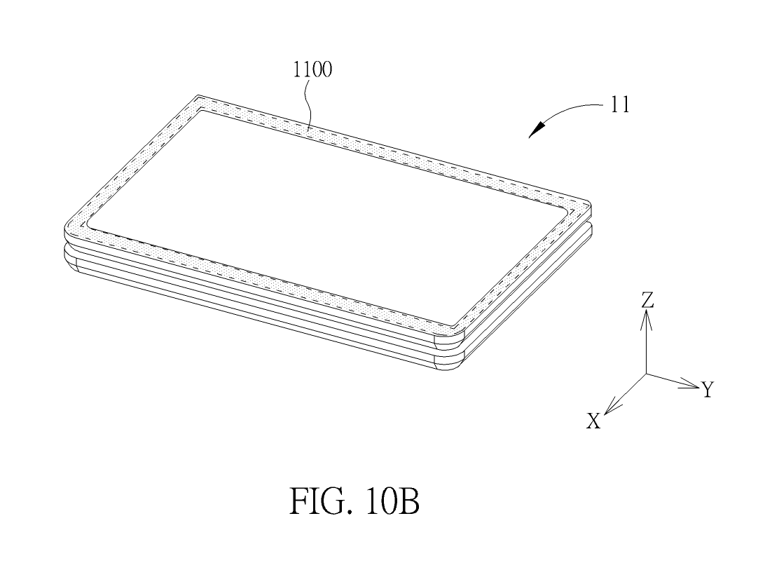

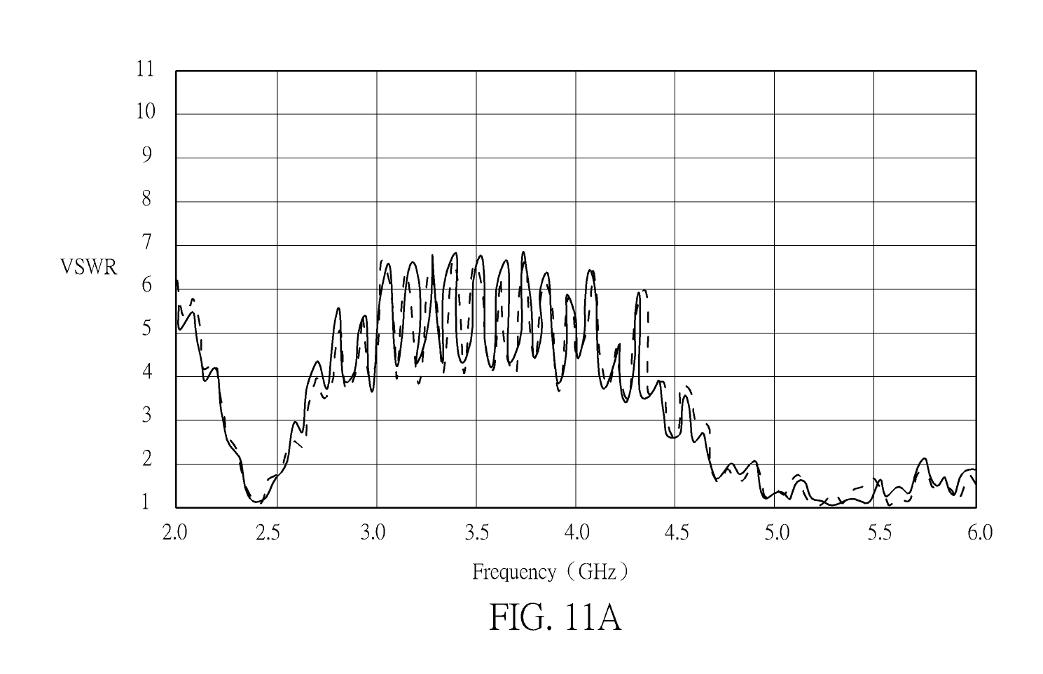

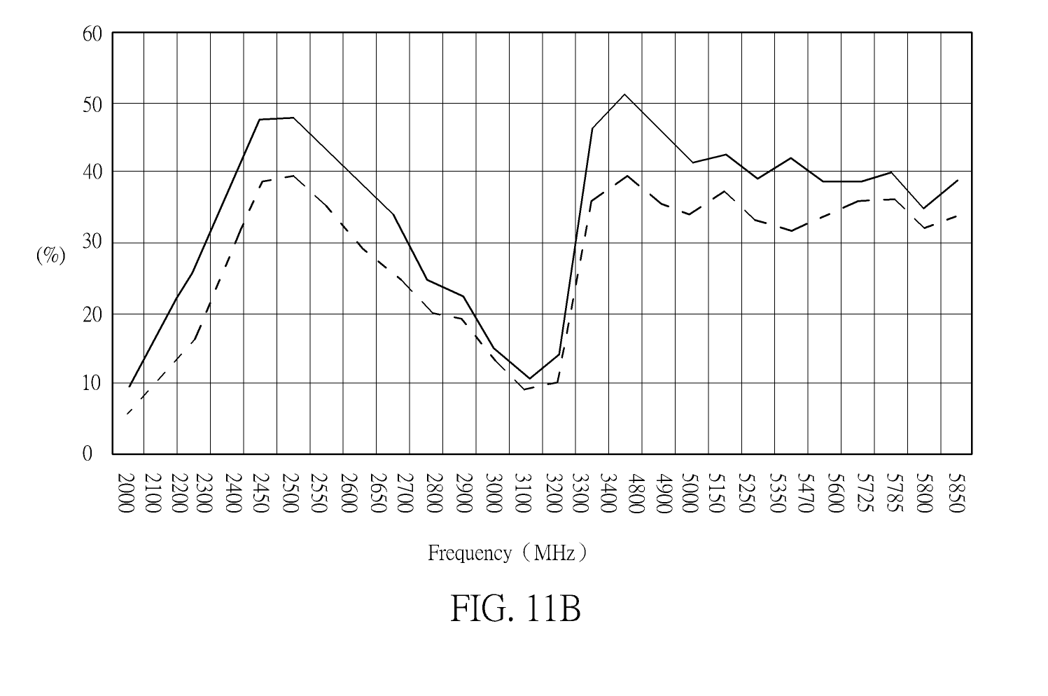

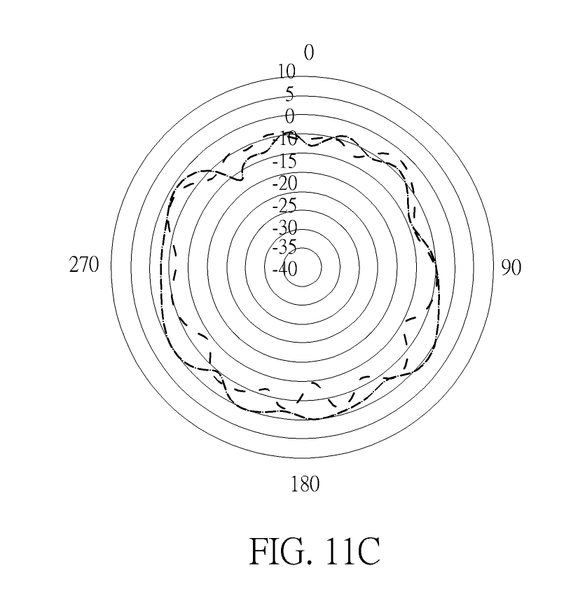

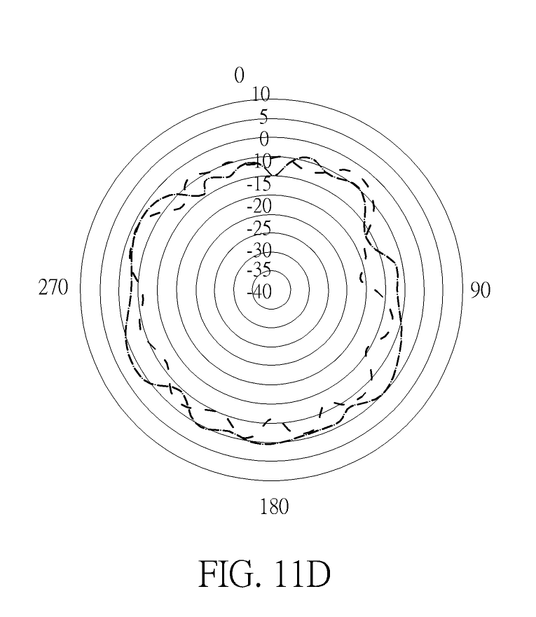

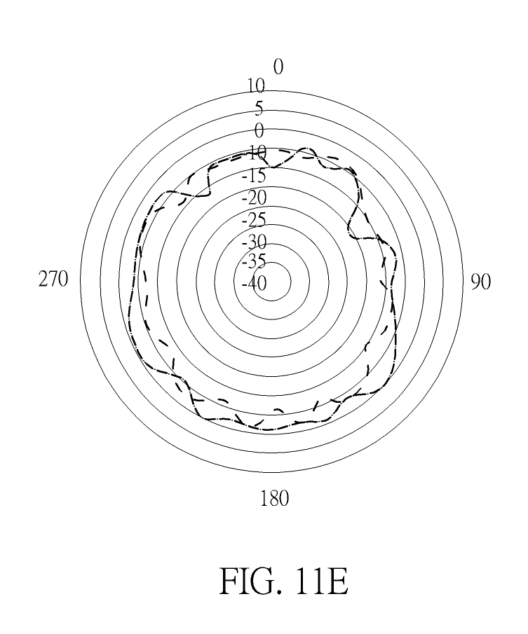

Furthermore, FIGS. 10A and 10B are schematic diagrams of two operation modes of a notebook 11 with a tablet function. The notebook 11 is also called yoga tablet, wherein a hinge connecting an up cover and a base allows repeated open and close, and may perform 360-degree rotation and folding, such that the notebook may operate either in a traditional open-cover laptop mode, as shown in FIG. 10A, or in a close-cover tablet mode, as shown in FIG. 10B. In such a situation, even if the notebook 11 covers the operating circuits by the metal back cover, the antenna of the present invention may be disposed on a region 1110 around the screen of the notebook 11. In such a situation, if the antenna 50 is disposed on the region 1100, for the two operation modes, the antenna 50 may reach VSWR, antenna efficiency, and antenna pattern respectively shown in FIGS. 11A-11E. In FIGS. 11A to 11E, solid lines and dashed lines represent the antenna properties of the notebook 11 in the open-cover mode (FIG. 10A) and in the close-cover mode (FIG. 10B), respectively. FIG. 11C to 11E represent the antenna patterns at 2400 MHz, 2450 MHz, and 2500 MHz, respectively. Therefore, as shown in FIGS. 11A to 11E, for the yoga tablet application, the antenna 50 may not only be applied on the metal back cover application, but also satisfy the tablet operation requirements of the close-cover mode.

Note that the aforementioned embodiments are for exemplarily illustrating the concept of the present invention, and those skilled in the art should readily make alterations and modifications according, but not limited thereto. For example, in addition to the aforementioned frequency adjustment or antenna properties optimization mechanisms (e.g., size of the metal sheet, length or height of the shorting wall, shape or structure of the section, length or height of the feed-in element), other factors, such as material of the base plate, material of the antenna, disposing position of the antenna may be modified adequately according to system requirements. Moreover, the aforementioned embodiments are exemplarily for the dual-band operation of 2.4 GHz and 5 GHz. In fact, the present invention may be applied on a single band operation, or, by regarding the high-frequency band as an aggregation of multiple subbands, the present invention may also be applied on operations occupied more than two bands, but not limited to dual-band operation.

In summary, the antennas of the embodiments of the present invention utilize the asymmetrical feed-in structures for activating dual-band operations, utilize the shorting walls for shortening the required widths, utilize the section structures for generating multiple patterns at high frequencies to widen the frequency ranges of high-frequency bands, and utilize a quarter wavelength impedance converter for matching the impedance point to 50 ohm to enhance transmission efficiency. Therefore, the antennas of the embodiments of the present invention have the advantages of wideband, multiband, small size, high efficiency, etc.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An antenna for an electronic device, comprising:
a grounding sheet, for providing grounding;
a metal sheet, having a shape substantially corresponding to a rectangle and a first section formed at a first corner of the rectangle;
a feed-in element, electrically connected to the metal sheet at a location corresponding to a second corner of the rectangle, for transmitting electromagnetic energy, wherein the second corner is adjacent to the first corner; and
a shorting wall, electrically connecting a first side of the metal sheet with the grounding sheet, for allowing the grounding sheet and the metal sheet to form a resonating cavity, wherein the first side is an opposite side of a second side of the metal sheet, and the second side is adjacent to both the first corner and the second corner;
wherein a length and a width of the rectangle to which the metal sheet corresponds are respectively related to frequency ranges of the at least an operating frequency band of the antenna, and the first section of the metal sheet is utilized for widening a frequency range of a first frequency band of the at least an operating frequency band.

2. The antenna of claim 1, wherein the grounding sheet comprises a first block and a second block connected to each other.

3. The antenna of claim 2, wherein the first block and the second block are disposed to form an included angle.

4. The antenna of claim 2, wherein the resonant cavity is formed between the metal sheet and the first block.

5. The antenna of claim 2, wherein the second block is electrically connected to a ground terminal.

6. The antenna of claim 5, wherein the ground terminal is further electrically connected to a metal back cover of the electronic device.

7. The antenna of claim 1, wherein the first section is substantially corresponding to a right-angled triangle.

8. The antenna of claim 7, wherein a hypotenuse of the right-angled triangle comprises a stepwise structure or an arc shape.

9. The antenna of claim 1, wherein the first section is substantially corresponding to a trapezoid.

10. The antenna of claim 1, wherein the metal sheet is further formed with a second section at a third corner of the rectangle, the third corner is an opposite corner of the first corner, and a shape of the second section is related to a frequency range of the at least an frequency band.

11. The antenna of claim 10, wherein the second section is substantially corresponding to a right-angled triangle.

12. The antenna of claim 11, wherein a hypotenuse of the right-angled triangle comprises a stepwise structure or an arc shape.

13. The antenna of claim 10, wherein the second section is substantially corresponding to a trapezoid.

14. The antenna of claim 1, wherein the feed-in element is a microstrip line, and a length of the microstrip line is related to a wavelength range of a wireless signal corresponding to a lowest frequency band of the at least an operating frequency band.

15. The antenna of claim 1, wherein the feed-in element comprises at least a bend.

16. The antenna of claim 1, wherein a distance between the second side of the metal sheet and the grounding sheet is greater than or equal to a height of the shorting wall.

17. The antenna of claim 1, further comprising a fixing element formed inside the resonating cavity, for fixing a relative position between the metal sheet and the grounding sheet.

18. The antenna of claim 1, disposed at a frame of a screen of the electronic device.

19. The antenna of claim 1, wherein the electronic device is a notebook, and the antenna is disposed around a keyboard of the notebook.

20. The antenna of claim 17, wherein a cross-section of the fixing element is in a shape of trapezoid or rectangle, or with an arc surface or a section.

21. An electronic device, comprising:
an operation circuit;
a metal housing, covering the operation circuit, and forming an open window; and
an antenna as claimed in claim 1.

22. The electronic device of claim 21, wherein the open window is for disposing a screen, and the antenna is disposed at a frame of a screen of the electronic device.

23. The electronic device of claim 21, being a notebook, wherein the open window is utilized for disposing a keyboard, and the antenna is disposed around the keyboard.
